(19) United States
(12) Patent Application Publication
(10) Pub. No.: US 2010/0271838 A1
(43) Pub. Date: Oct. 28, 2010

(54) Surface Light Source Device and Display

(76) Inventor: Masao Yamaguchi, Saitama (JP)

Correspondence Address: STAAS & HALSEY LLP, SUITE 700, 1201 NEW YORK AVENUE, N.W., WASHINGTON, DC, 20005, US

(21) Appl. No.: 12/223,251

(22) PCT Filed: Jan. 25, 2007
(86) PCT No.: PCT/JP2007/051155

§ 371 Date: Jul. 2, 2010

(30) Foreign Application Priority Data
Jan. 27, 2006 (JP) 2006-019090
Jun. 23, 2006 (JP) 2006-174600

(51) Int. Cl. F21V 8/00; G09F 13/08

(52) U.S. Cl. 362/602; 362/237

(57) ABSTRACT

A surface light source device illuminating a displaying member of a display comprises stacked first and second light guide plates between which a low-refractive-index-layer is interposed. The light guide plates are disposed so that side end faces of light incidence sides of the light guide plates located oppositely to each other and an emission face of the first light guide plate is opposite to a back face of the second light guide plate across the low-refractive-index-layer interposed between the light guide plates. Each of light guide plates has an emission-restraint-region, an emission-gradual-increase-region and an emission-promotion-region which are formed as to be located in order away from an incidence side toward a distal end face. Although each of light source groups consists of at least two point-like-light-sources emitting light of different colors, light of various colors undergoes color mixing in each emission-restraint-region, thereby preventing emission from the emission face of the second light guide plate from showing color unevenness.

### FIELD OF INVENTION

The present invention relates to a surface light source device and a display employing the surface light source device, being able to be applied to surface-like illumination means for displays (for example, backlight arrangement means for LCD-panels) also to displays comprising such the surface-like illumination means.

### BACKGROUND ARTS

In general, devices such as car navigation devices, video cameras, digital still cameras, electronic pocket notebooks, portable telephones, portable mobile terminal devices, personal computers, or LCD-TV sets are equipped with displays. A typical display employs a LCD-panel, as a displaying member, which is illuminated by a surface light source device employing a light guide plate. Usually, the light guide plate is supplied with light from a primary light source disposed in the vicinity of a side face. Rod-like fluorescent lamps have been adopted broadly as primary light sources. Light sent into a light guide plate from a fluorescent lamp is emitted from an emission face (a major face) gradually on the way of inner-propagation, illuminating an object-to-be-illuminated (LCD-panel).

However, fluorescent lamps employed as primary light sources gives large load to environment on disposal because they contain mercury inside. In addition, a problem of large electric power consumption arises. Further saying, color-displaying with LCD-panels have become popular and demand for high color-fidelity are now arising.

Thus employment of point-like-light-sources like LEDs instead of fluorescent lamps has been proposed and realized in many cases already. In particular, development of available blue-light-emitting LED has enabled LED-light-emitting-elements supplying white primary light to be used. This is called “white LED”.

Employment of white-LED(s) as a primary light source(s) enables surface light source devices which allow low electric power consumption and high density mounting (structure free from demand for inverter) to be provided. Examples are given by surface light source devices disclosed in Document 1 noted below.

On the other hand, displays of high color-fidelity such as plasma display have appeared in recent years, and image-displaying quality of them has been compared with that of liquid crystal display (display utilizing LCD-panel). Thus liquid crystal displays are now subject to severe demand for color-displaying quality (color fidelity).

According to a proposed method for answering such demand, a plurality of LEDs emitting light of three primary colors, R (red), G (green) and B (blue) are used to obtain white color. It is known that this method can provide higher color fidelity as compared with cases where white LED(s) is (are) used.

A prior art using such LEDs emitting light of three primary colors, R, G and B is disclosed in Document 2 noted below. Referring to FIG. 15, illustrated is surface light source device 100 in accordance with this prior art (first prior art). Surface light source device 100 comprises point-like-light-source module 104 including LEDs 104r, 104g, 104b of respective colors, R, G, B, light guide plate 101 for mixing, light guide plate 102 and reflector 103.

Light guide plate 101 for mixing mix light of respective colors from point-like-light-source module 104 for whitening, then emitting from top end face 106. This light is redirected at reflector 103 by 108 degrees to be guided to end face 107 of light guide plate 102. White light guided to end face 107 enters into light guide plate 102 through end face 107, then being emitted from emission face as surface-like light and supplied to LCD-panel 110.

However, surface light source device 100 is apt to have a reduced light utilizing efficiency and cannot expect provide high-brightness white surface-like illumination because light emitted from respective LEDs 104 has a long guiding distance and has to be redirected via reflector 103 by 180 degrees.

It is noted that Document 3 discloses surface light source devices (second prior art) outward appearance of which resembles that of the surface light source device in accordance with the embodiment of the present invention described later. FIG. 16 shows outlined structure thereof. As shown in FIG. 16, surface light source device 200 utilizes two light guide plates which are stack-disposed. So far as this, surface light source device 200 seems to resemble surface light source devices in accordance with the present invention.

However, surface light source device 200 employs fluorescent lamp 201 as a primary light source. In addition, stacked light guide plates 102, 103 have back faces 204, 205 to which grid-like-point-pattern is printed overall. This functions merely as to uniformalize emission brightness, being completely different in constitution and effects from surface light source device 2 in accordance with the present invention that is capable of emitting light which has been whitened through sufficient color mixing of R, G, B.

Document 1; Tokkai-Hei 10-97200

Document 2; Tokkai 2005-276734

Document 3; Tokkai-Hei 8-240721

### DISCLOSURE OF INVENTION

An object of the present invention is to improve a surface light source device employing at least two point-like-light-sources providing light of mutually different colors as a primary light source so that light of such different colors is mixed sufficiently enough to avoid surface-like illumination light from having color unevenness.

Another object of the present invention is to provide a display capable of performing high-quality displaying by employing the improved surface light source device.

Still another object of the present invention is to provide a surface light source device capable of outputting white light free from color unevenness by utilizing the above improvement and a display capable of performing high-quality displaying by employing the same.

First, the present invention is applied to a surface light source device comprising a first light guide plate having a first side end face, a first emission face and a first back face opposite to said first emission face, a first light source group for supplying first illumination light which is disposed along said first side end face and consists of at least two point-like-light-sources providing light of mutually different colors, a second light guide plate having a second side end face, a second emission face and a second back face opposite to said second emission face, a second light source group for supplying second illumination light which is disposed along said second side end face and consists of at least two point-like-light-sources providing light of mutually different colors and a layer refractive index of which is lower than that of first light guide plate.

According to a feature of the present invention, said first light guide plate and said second light guide plate are stack-disposed so that said layer is interposed between said first emission face of said first light guide plate and said second back face of said second light guide plate and said first side end face is located oppositely to said second side end face.

And, said first light guide plate has a first emission-restraint-region for restraining said first illumination light from being emitted from said first emission face, a first emission-promotion-region for promoting emission of said first illumination light from said first emission face and a first emission-gradual-increase-region bridging said first emission-restraint-region and said first emission-promotion-region.

On the other hand, said second light guide plate has a second emission-restraint-region for restraining said second illumination light from being emitted from said second emission face, a second emission-promotion-region for promoting emission of said second illumination light from said second emission face and a second emission-gradual-increase-region bridging said second emission-restraint-region and said second emission-promotion-region.

Said first emission-restraint-region is located nearer to said first side end face than said first emission-gradual-increase-region and said first emission-promotion-region is located father from said first side end face than said first emission-gradual-increase-region. And said second emission-restraint-region is located nearer to said second side end face than said second emission-gradual-increase-region and said second emission-promotion-region is located father from said second side end face than said second emission-gradual-increase-region.

Typically, illumination output light outputted from said second emission face is white light. Thickness of said first light guide plate may decrease gradually away from said first side end face as to render said first light guide plate configured wedge-like and thickness of said second light guide plate may decrease gradually away from said second side end face as to render said second light guide plate configured wedge-like.

Alternately, thickness of said first light guide plate may decrease gradually in said first emission-promotion-region away from said first side end face and thickness of said second light guide plate may decrease gradually in said second emission-promotion-region away from said second side end face.

Further saying, said first light guide plate my be shaded at a distal end located opposite to said first side end face and said second light guide plate may be shaded at a distal end located opposite to said second side end face.

The present invention is also applied to a display comprising a surface light source device and a displaying member illuminated by output light outputted from said surface light source device. According to a feature of the present invention, as this surface light source device employed is any of the above-mentioned surface light source devices.

With a surface light source device in accordance with the present invention, since a first light guide plate has a first emission-restraint-region in light incidence side for first illumination light, a great part of first illumination light is emitted from a first emission face and enters into a second light guide plate after being mixed sufficiently, then being emitted from a second emission face.

On the other hand, a great part of second illumination light is emitted from a second emission face after being mixed sufficiently, because a second light guide plate has a second emission-restraint-region in light incidence side for second illumination light. Thus color mixing regions in which light of a plurality of colors is mixed mutually are formed in first and second emission-restraint-regions.

Besides, emission from the second emission face is rendered uniform as a whole since the first emission-restraint-region of the first light guide plate and the second end emission-restraint-region of the second light guide plate are located oppositely to each other. As a result, the surface light source device provides output illumination light (emission light from the second emission face) which has uniformity as a whole in color and intensity.

If emission colors of point-like-light-sources employed in first and second light source groups are selected as to produce white light through being light-color-mixed, the surface light source device provides output illumination light which is free from unevenness in color and brightness.

These advantages heighten displaying quality of a displaying member illuminated by illumination output light of the above surface light source device. In particular, if the displaying member is a color-displaying LCD-panel, high quality color displaying is able to be realized.

### BRIEF DESCRIPTION OF DRAWINGS

FIG. 1 is an exploded perspective view of a display of an embodiment in accordance with the present invention;

FIG. 2 is a cross section view of the display along line Y-direction in FIG. 1;

FIG. 3a is a plan view of the display as shown in FIG. 1, with LCD-panel (object-to-be-illuminated), first and second light control members being removed;

FIG. 3b is a partial plan view of the display for illustrating mixing state of light from a plurality of LEDs;

FIG. 4 is a diagram showing emission brightness curves together with a cross section shape, illustrated correspondingly, of a main part of a surface light source device with which the display shown in FIG. 1 is equipped;

FIG. 5a is a partially enlarged cross section view of the surface light source device with which the display shown in FIGS. 1 to 3a, 3b is equipped;

FIGS. 5b through 5d are partially enlarged cross section views for illustrating four kinds of arrangements in accordance with Modification 1 of the surface light source device shown in FIG. 5a, respectively;

FIG. 6 is a partial cross section view of a surface light source device in accordance with Modification 2 of the present invention;

FIG. 7 is a partial cross section view of a surface light source device in accordance with Modification 3 of the present invention;

FIG. 8 is a partial cross section view of a surface light source device in accordance with Modification 4 of the present invention;

FIG. 9 is a partial cross section view of a surface light source device in accordance with Modification 5 of the present invention;

FIG. 10a is a cross section view of a surface light source device in accordance with Modification 7 of the present invention;

FIG. 10b is an enlarged view of part A in FIG. 10a;

FIG. 10c is an enlarged view of part B in FIG. 10a;

FIG. 11 is a diagram showing a brightness distribution curve of emission from a second light guide plate together with a cross section shape diagram, illustrated correspondingly, of the surface light source device in accordance with Modification 7;

FIG. 12a is a plan view of a surface light source device in accordance with Modification 8 of the present invention in a case where an incidence face is provided with no angle-expansion-means (first light guide plate side is not shown);

FIG. 12b is a plan view for illustrating a surface light source device of reference to be compared with Modification 8 (first light guide plate side is not shown);

FIG. 12c is a plan view of the surface light source device in accordance with Modification 8 (first light guide plate side is not shown);

FIG. 12d is a partially enlarge 4d view of FIG. 12c;

FIG. 12e illustrates another mode of angle-expansion-means (illustrated correspondingly to FIG. 10d);

FIG. 13a is an enlarged view of a main part of FIG. 12d;

FIG. 13b is a cross section view along line D1-D1 in FIG. 13a;

FIG. 14a is a diagramic plan view of the surface light source device of Modification 8 as viewed from second light guide plate side for illustrating results of measurement performed for Modification 8;

FIG. 14b is a chart showing u′ values (coordinate values for Red-Green axis in CIE 1976 UCS chromaticity chart) obtained through chromaticity measurement applied to a plurality of points in a center portion of the second light guide plate shown in FIG. 14a;

FIG. 14c is a chart showing v′ values (coordinate values for Yellow-Blue axis in CIE 1976 UCS chromaticity chart) obtained through chromaticity measurement applied to a plurality of points in the center portion of the second light guide plate shown in FIG. 14a;

FIG. 14d is a chart showing u′ values (coordinate values for Red-Green axis in CIE 1976 UCS chromaticity chart) obtained through chromaticity measurement applied to a plurality of points in an end portion opposite to an incidence face of the second light guide plate shown in FIG. 14a;

FIG. 14e is a chart showing v′ values (coordinate values for Yellow-Blue axis in CIE 1976 UCS chromaticity chart) obtained through chromaticity measurement applied to a plurality of points in the end portion opposite to an incidence face of the second light guide plate shown in FIG. 14a;

FIG. 15 is a cross section view of a surface light source device in accordance with a first prior art; and

FIG. 16 is a cross section view of a surface light source device in accordance with a second prior art.

### EMBODIMENT

### Structure of Surface Light Source Device and Display Including the Same

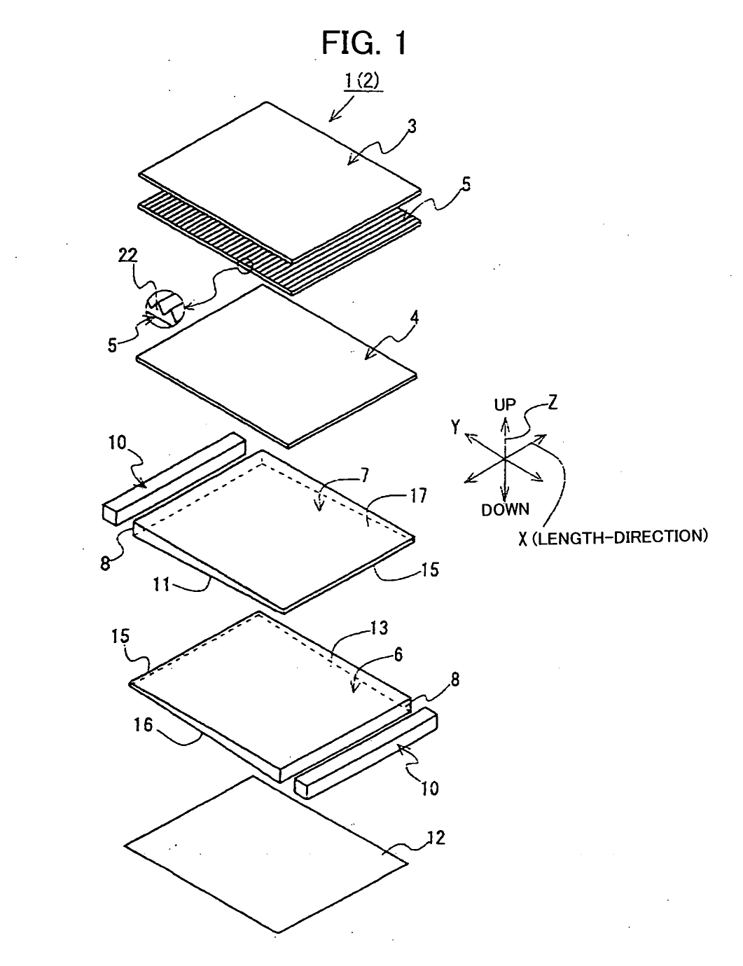

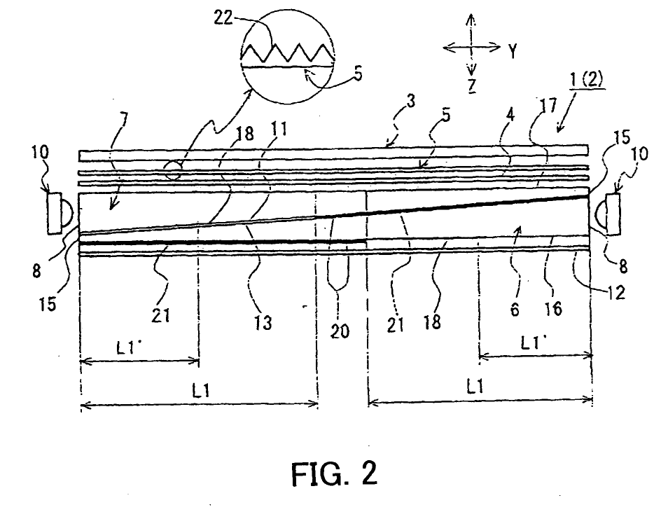

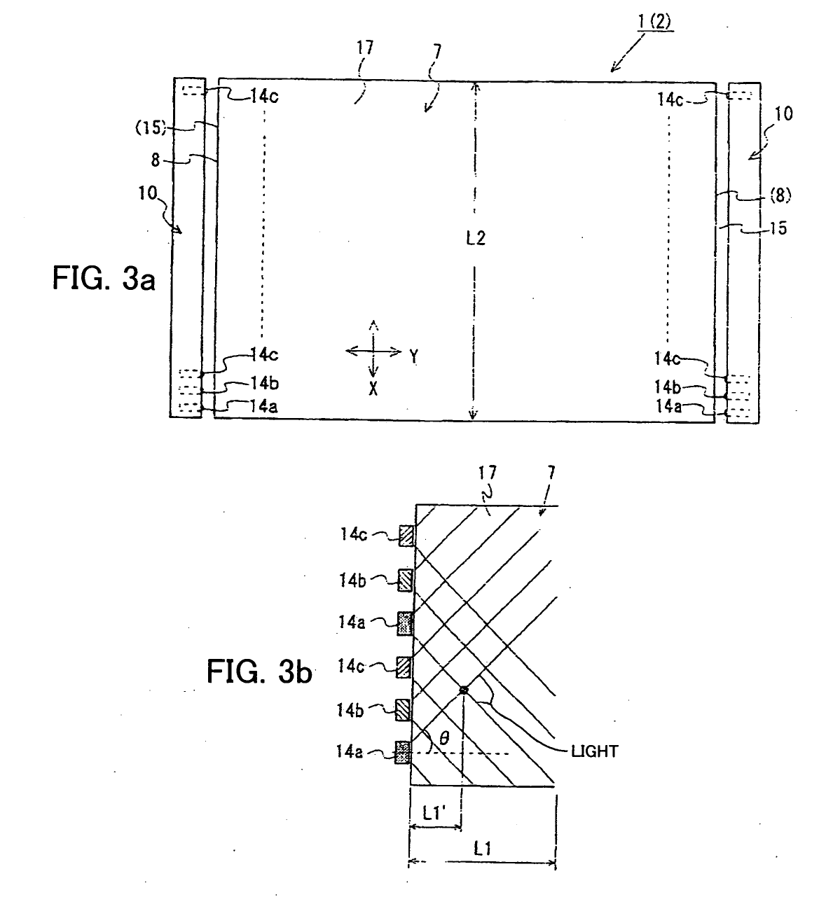

FIGS. 1 to 3a, 3b illustrate display 1 of the embodiment. FIG. 1 is an exploded perspective view of display 1 and FIG. 2 is a cross section view along line Y-direction in FIG. 1. FIG. 3a is a plan view of display 1, with LCD-panel (an example of object-to-be-illuminated) 3, first and second light control members 4, 5 being removed. FIG. 3b is a partial plan view of display 1 for illustrating mixing state of light from a plurality of LEDs.

Liquid crystal display 1 comprises LCD-panel 3 illuminated by surface light source device 2 two-dimensionally. Surface light source device 2 comprises first and second light guide plates 6, 7 stack-disposed vertically, point-like-light-source units 10, 10 respectively disposed along side end faces (incidence faces=first and second side end faces) 8, reflection sheet 12, first light control member 4 and second light control member 5.

Reflection sheet 12 is disposed along a lower face (=first back face) 16 of first light guide plate 6, in other words, the lower side light guide plate. First light control member 4 is disposed along an upper face (=second emission face) 17 of second light guide plate 7, in other words, the upper side light guide plate. Second light control member 5 is stack-disposed on an upper face (i.e. outside of) first light control member 4.

Point-like-light-source units 10,10 are primary light sources respectively consisting of at least two point-like-light-sources providing light of mutually different colors. According to the embodiment, LEDs 14a, 14b and 14c respectively emitting light of primary colors, R (red), G (green) and B (blue). In each unit 10, one LED 14a, one LED 14b and one LED 14b forms a set. Usually, each unit 10 is provided with a plurality of sets of LEDs 14a, 14b and 14c.

Thus, In general, a plurality of sets of LEDs 14a, 14b and 14c are arrayed alternately along each incidence face 8. It is noted that only three LEDs 14a, 14b and 14c near to both ends of each incidence face 8 are shown in FIG. 3a, with the other LEDs are not shown.

As described later, upper face 17 of light guide plate 7 outputs white light generated by synthesizing (mixing) light of three primary colors provided by LEDs 14a, 14b and 14c so that an emission surface of surface light source device 2 gives highly even brightness overall.

First light guide plate 6 has distal end side face 15 located at a distal end opposite to incidence face (first side side end face) 8. In a similar way, second light guide plate 7 has distal end side face 15 located at a distal end opposite to incidence face (second side end face) 8. Further, second light guide plate 7 is disposed on first light guide plate 6 so that incidence face (second side end face) 8 of second light guide plate 7 corresponds to distal end face (first distal end face) 15 of first light guide plate 6 and distal end face (second distal end face) 8 of second light guide plate 7 corresponds to incidence face (first side end face) 8 of first light guide plate 6.

(First Light Guide Plate and Second Light Guide Plate)

First light guide plate 6 and second light guide plate 7 are made of a light permeable material such as polymethyl methacrylate (PMMA), polycarbonate (PC) or cycloolefin type resin. A face opposite to upper face (second emission face) 17 of second light guide plate 7 is back face (second back face) 11 which faces upper face (first emission face) 13 of first light guide plate 6.

As shown in FIGS. 1 to 3a, first light guide plate 6 and second light guide plate 7 have quadrangle plan shapes, respectively, having thickness decreasing away from respective incidence faces 8. In other words, first light guide plate 6 and second light guide plate 7 are optical members of wedge-like shape. Thickness is the maximum(s) at respective incidence faces 8 of first light guide plate 6 and second light guide plate 7. In addition, ta, thickness is the minimum(s) at respective distal end faces 15 of first light guide plate 6 and second light guide plate 7.

Such combination of first light guide plate 6 and second light guide plate 7 enables surface light source device 2 to have a uniformalized thickness (dimension along Z-direction in FIGS. 1 and 2) and to be advantageous accordingly for being made compact.

As shown in FIG. 2, first emission face 13 provides a slope inclined with respect to first back face 16. In a similar way, second back face 11 provides a slope inclined with respect to second emission face 17. A thin air layer exists between second back face 11 and first emission face 13. Needless to say, the thin air layer has refractive index which is approximately equal to 1.0 and smaller than that of any other optical material.

It is important that first light guide plate 6 and second light guide plate 7 have means for restraining “emission before sufficient color mixing”. That is, back face 16 of first light guide plate 6 provides a flat-and-smooth surface covering a range of predetermined dimension (L1) from incidence 8 toward distal end face 15. This restrains emission from first emission face 13. In this sense, this region of back face 16 provides emission-restraint-region (emission-restraint-region) 18 restraining emission from first emission face 13.

In a similar way, back face 11 of second light guide plate 7 provides a flat-and-smooth surface covering a range of predetermined dimension (L1) from incidence 8 toward distal end face 15. This restrains emission from second emission face 17. In this sense, this region of back face 17 provides emission-restraint-region (second emission-restraint-region) 18 restraining emission from first emission face 13.

The above predetermined dimension (L1) of each of emission-restraint-regions 18, 18 is a distance from each incidence face 8 enough to cause R, G and B of LEDs 14a, 14b and 14c to be mixed sufficiently (in the embodiment, to be whitened). Now provided that light of LEDs 14a, 14b and 14 begin mixing at distance L1′ from incidence face 8, L1>L1′ is satisfied. Distance L1′ can be estimated, for example, as follows.

L1′=P/(2·tan θ)

As shown in FIG. 3b, θ in the above formula is an angle range (i.e. angle range within which emission intensity is not smaller than half-vague of the maximum intensity) of incidence light, which is provided by light emitted from respective LEDs 14a, 14b and 14c . . . after the light is incident to incidence face 8, on a plane of directions parallel to emission face 13. In addition, P is a pitch of LEDs of the same emission color.

If distance between LEDs 14a-14a is Pa, distance between LEDs 14b-14b is Pb and distance between LEDs 14c-14c is Pc, P can be set as P=Pa(=Pb=Pc) under Pa=Pb=Pc. Further saying, if any difference exists among Pa, Pb and Pc, it is preferable that P is set as to be equal to the maximum of Pa, Pb and Pc.

If any device for increasing expanse angle θ is applied to incidence face 8 or the neighbourhood thereof, L1′ can be set smaller as compared with L1′ in cases where such device is not applied. It is, how ever, to be noted that predetermined distance L1 of emission-restraint-region 18 needed for ensuring sufficient whitening is preferably satisfy L1>L1′ because L1′ is distance (from incidence face 8) needed for beginning of mixing of light of the same color. In general, set is optimum dimension adjusted depending on values of thickness of first and second light guide plates 6, 7 and emission characteristics of LEDs 14a to 14c.

Now provided is that dimension along length-direction (X-direction) of respective incidence faces 8 of first light guide plate 6 and second light guide plate 7 is L2. Thus area of respective emission-restraint-regions 18,18 is (L1)×(L2). In addition, a region having area of (L1′)×(L2) is a light-mixing-region.

Back face 16 of first light guide plate 6 includes emission-promotion-region (first emission-promotion-region) 21 remote from incidence face (first side end face) 8. In addition, emission-gradual-increase-region (first emission-gradual-increase-region) 20 is formed between first emission-restraint-region 18 and first emission-promotion-region 21.

In a similar way, back face 11 of second light guide plate 7 includes emission-promotion-region (second emission-promotion-region) 21 remote from incidence face (second side end face) 8. In addition, emission-gradual-increase-region (second emission-gradual-increase-region) 20 is formed between second emission-restraint-region 18 and second emission-promotion-region 21.

Each emission-promotion-region 21 is formed as to cover predetermined distance (L1) from each distal end side face 15. According to resultant relation, first emission-restraint-region 18 is overlapped with second emission-promotion-region 21 and second emission-restraint-region 18 is overlapped with first emission-promotion-region 21, as shown in FIG. 2. In addition, first and second emission-gradual-increase-regions 20, 20 are also overlapped with each other.

Each emission-promotion-region 21 is provided with emission-promotion-means for promoting emission from emission face 13 or 17. The emission-promotion-means may be satin surface, furrow-like micro-prismatic projections, blasting-processed surface, micro-projections like pyramids or cones, rough surface such as surface with micro-recesses or ink printing with light reflectivity, so far as emission from emission face 13 or 17 is promoted.

Each emission-gradual-increase-region is an “intermediate” connecting each emission-restraint-region 18 with each emission-promotion-region 21, being a region in which emission promoting ability increases gradually according to increase in distance from each incidence face 8. Boundary between each emission-gradual-increase-region 20 and each emission-restraint-region 18 and boundary between each emission-gradual-increase-region 20 and each emission-promotion-region 21 are give preferably no sharp changing of emission promoting ability.

In other words, each emission-gradual-increase-region 20 loses emission restraining ability gradually away from each incidence face 8 and increases in emission promoting ability with approaching emission-promotion-region 21.

Therefore the above-mentioned emission-promotion-means is applied on each emission-gradual-increase-region 20 so that formation-density thereof increases gradually and smoothly from non-dense to dense.

Further, formation-density of emission-promotion-means in each emission-gradual-increase-region 20 falls gradually from boundary between each emission-gradual-increase-region] 20 and each emission-promotion-region 21 toward boundary between emission-gradual-increase-region 20 and each emission-restraint-region 18, being equal to zero at boundary between emission-gradual-increase-region 20 and each emission-restraint-region 18.

It is noted that emission-promotion-means applied to each emission-promotion-region 21 and emission-promotion-means applied to emission-gradual-increase-region 20 may be of different kinds (for example, satin surface and furrow-like micro-prismatic-projection-formed surface), so far as surface light source device 2 gives no unnatural visual feeling and no unnatural emission brightness.

(First Light Control Member and Second Light Control Member)

First and second light control members 4, 5 are film-like member made of wee-light-permeable resin material (such as polyethylene terephthalate (PET), polymethyl methacrylate (PMMA) or polycarbonate (PC)). As shown in FIGS. 1 and 2, each light control member 4, 5 has a quadrangle plan shape generally the same as that of emission face 17 of second light guide plate 7. In the embodiment, first light control member 4 has light diffusion function and second light control member 5 has light redirecting function.

At least of an inner face (facing emission face 17) and an outer face (facing second light control member 5) of first light control member 4 provides a rough surface, thereby diffusing emission from emission face 17 and supplying to second light control member 5. In addition, this due to this diffusion action by the rough surface, emission-promotion-means (for example, rough surface) applied to first light guide plate 6 and second light guide plate 7 is hardly visible as viewed from the outside of LCD-panel 3.

Second light control member 5 has an outer face (upper face; facing LCD-panel 3) providing a prismatic surface, as shown in FIGS. 1 and 2. Such a light control member is called upward prism sheet. The prismatic surface is provided with a great number of prismatic projections 22, formed continuously like furrows, each having triangle-like cross section and running in length-direction (X-direction) of respective incidence faces 8 of first light guide plate 6 and second light guide plate 7.

According to well known function of second light control member 5, travelling directions of light diffused by first light control member 4 are modified as to come close to a frontal direction of emission face 17, thereby causing light incident to a back face of LCD-panel 3 at a right angle or approximately right angle to be increased.

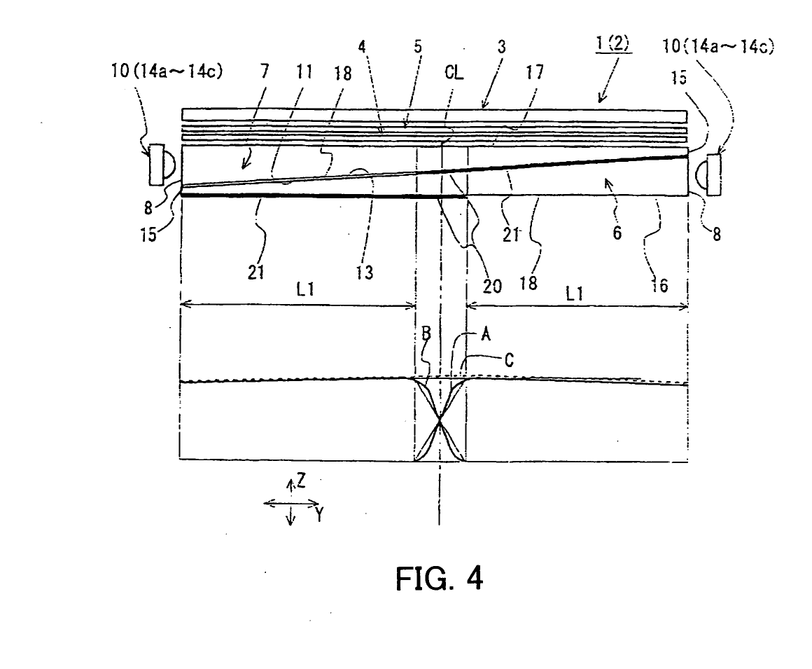

Next, described is brightness characteristics of emission from emission face 17 of surface light source device 2, with FIG. 4 being referred to. FIG. 4 shows curves (solid lines A, B and dotted line C) of brightness characteristics under three lighting conditions (first lighting condition through third lighting condition). The three lighting conditions are as follows.
Solid line A; First lighting condition=Switched on are only LEDs 14a, 14b and 14c constituting point-like-light-source unit 10 for light supply to second light guide plate 7 Only second illumination light is supplied).

Solid line B; Second lighting condition=Switched on are only LEDs 14a, 14b and 14c constituting point-like-light-source unit 10 for light supply to first light guide plate 6 Only first illumination light is supplied).

Dotted line C; Third lighting condition=Switched on are LEDs 14a, 14b and 14c of both point-like-light-source units 10, 10 (First illumination light and second illumination light are supplied).

The followings are understood from FIG. 4.

(1) as shown by solid line A, emission hardly occurs in emission-restraint-region (second emission-restraint-region) 18 of second light guide plate 7. That is, second illumination light is restrained from being emitted from second emission face 17 in emission-restraint-region (second emission-restraint-region) 18 of second light guide plate 7.

In emission-gradual-increase-region (second emission-gradual-increase-region) 20, emission brightness rises smoothly and gradually away from second emission-restraint-region 18. Entering second emission-promotion-region 21, emission brightness is kept generally constant (slightly getting low toward distal side end face 15).

(2) A shape depicted by solid line B is generally symmetric to solid line A with respect to center line (CL) extending in a direction vertical to incidence face 8 of first light guide plate 6. In other words, first illumination light is restrained from being emitted from first emission face 13 in emission-restraint-region (first emission-restraint-region) 18 of first light guide plate 6.

In emission-gradual-increase-region (first emission-gradual-increase-region) 20, emission brightness rises smoothly and gradually away from first emission-restraint-region 18. Entering first emission-promotion-region 21, emission brightness is kept generally constant.

(3) A shape depicted by dotted line C is one provided by synthesizing up solid line A and slid line B additively. Expressing symbolically, C=A+B.

Although dotted C is the highest at center line (CL) extending in the direction (Y-direction) vertical to incidence face 8 of first light guide plate 6 and emission brightness is apt to get low slightly toward respective distal end side faces 15 from there, emission brightness is generally constant as a whole.

Thus the embodiment brings broadly uniform emission brightness. In addition, light utilization efficiency is heightened as compared with aforementioned prior art (surface light source device 100). The reason of this is that surface light source device 100 has a longer light guiding length due to light guiding within light guide plate for mixing 101 and light guide plate 102, being likely to reducing light utilization efficiency.

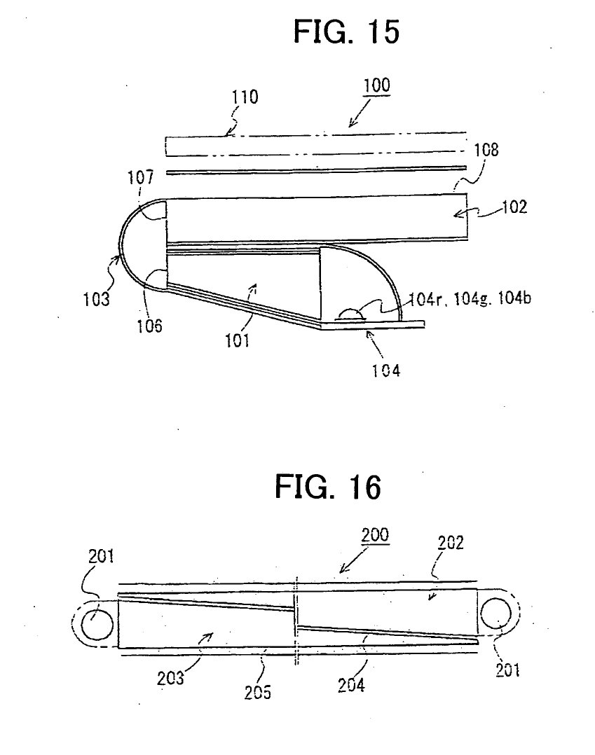

Further to this, 180 degree redirecting of light by reflector 103 as shown in FIG. 15 reduces light utilization efficiency. With surface light source device 2, such 180 degree redirecting of light by a reflector is not needed.

Still further, according to the embodiment, a pair of (i.e. two) point-like-light-source units can be arranged with a reduced thickness, under a condition such that surface light source device 2 has generally the same emission area as compared with that of prior arts. Accordingly, surface light source devices and displays can not only be made compact with ease but also emission brightness of light (white light, in the case of embodiment) obtained by emission color mixing (color-mixing) of LEDs.

Still further, according to the embodiment, a great part of first illumination light is emitted from emission face 13 above first emission-gradual-increase-region 20 and first emission-promotion-region 21 after undergoing sufficient emission color mixing due to action of first emission-restraint-region 18 formed in the vicinity of incidence face 8 of first light guide plate 6, then being supplied to second light guide plate 7. Much of this light is emitted from emission face 17. Such light is called first emission (emission originated from first illumination light).

On the other hand, a great part of second illumination light is emitted from emission face 17 above second emission-gradual-increase-region 20 and second emission-promotion-region 21 after undergoing sufficient emission color mixing due to action of second emission-restraint-region 18 formed in the vicinity of incidence face 8 of second light guide plate 7. Such light is called second emission (emission originated from second illumination light).

After all, emission face 17 provides first emission and second emission. Therefore none of first emission and second emission scarcely become light which has failed to be color-mixed enough. In the case of the embodiment, uniform white light with reduced color unevenness is emitted from emission face 17 since white light is generated by color-mixing.

In addition, as referred to already, although known are surface light source devices (second prior art) outward appearance of which resembles that of surface light source device 2 in accordance with the embodiment, they are completely different in constitution and effects from surface light source device 2.

(Modification 1)

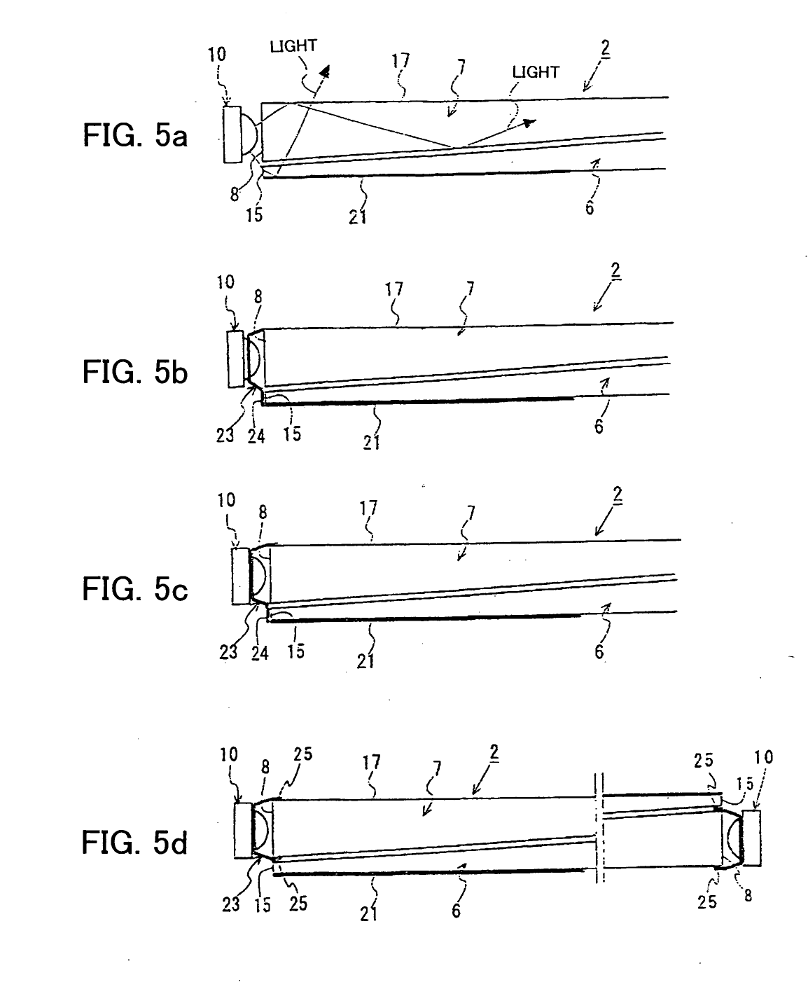

FIG. 5a is a partially enlarged cross section view of surface light source device 2 shown in FIGS. 1 to 3a, 3b. FIGS. 5b through 5d are partially enlarged cross section views for illustrating arrangements in accordance with Modification 1 of surface light source device 2. It is noted that respective sides of incidence faces 8 of second light guide plates 7 are partially enlarged conveniently for the sake of illustration.

Referring to FIGS. 5b and 5c, frame 23 of point-like-light-source unit 10 for supplying second illumination light, at a lower end side of which skirt portion 24 for shading is formed as to contact closely with the whole surface of distal end face 15 of first light guide plate 6. This prevents light from leaking through distal end face 15 of first light guide plate 6 and from then being incident to first light guide plate 6. It is noted that frame 23 may be made of plastic or metal.

In a similar way, skirt portion (24) for shading, not shown, is formed, at an upper end side of point-like-light-source unit (10) for supplying first illumination light, as to contact closely with the whole surface of distal end face (15) of second light guide plate 7 (See FIG. 2). This prevents light from leaking through distal end face 15 of second light guide plate 7 and from then being incident to second light guide plate 7.

Alternatively, skirt portion 24 with which frame 23 provided may be omitted and, instead, incidence face(s) 8 may be pinched by visor portions 25, 25 of 23 shaped up-down-symmetric as shown in FIG. 5d. In this case, light is prevented from being incident to first or second light guide plate 6, 7 via distal end face 15, too.

According to Modification 1, light of unnecessary colors (light color-mixed not enough, which would be introduced through distal end faces 15) is prevented from being added to light (sufficiently color-mixed light; white light, in the embodiment) emitted from emission faces 13 and 17 above first and second emission-promotion-regions 21. Therefore still more uniform color-mixed light (white light, in the embodiment) is emitted from emission face 17.

It is noted that an upper end side, not provided with skirt portion 24, of frame 23 of point-like-light-source unit 10 employed in Modification 1 may abuts an upper end of incidence face 8 of second light guide plate 7 (See FIG. 5b) or, visor portion 25 may be closely contact-engaged with (caught on) emission face 17 at the vicinity of incidence face 8 of second light guide plate 7.

In addition, constitution of frame 23 as shown in any of FIGS. 5b to 5d may be applied to a frame of the point-like-light-source unit, not shown, of first light guide plate 6 as a modification.

(Modification 2)

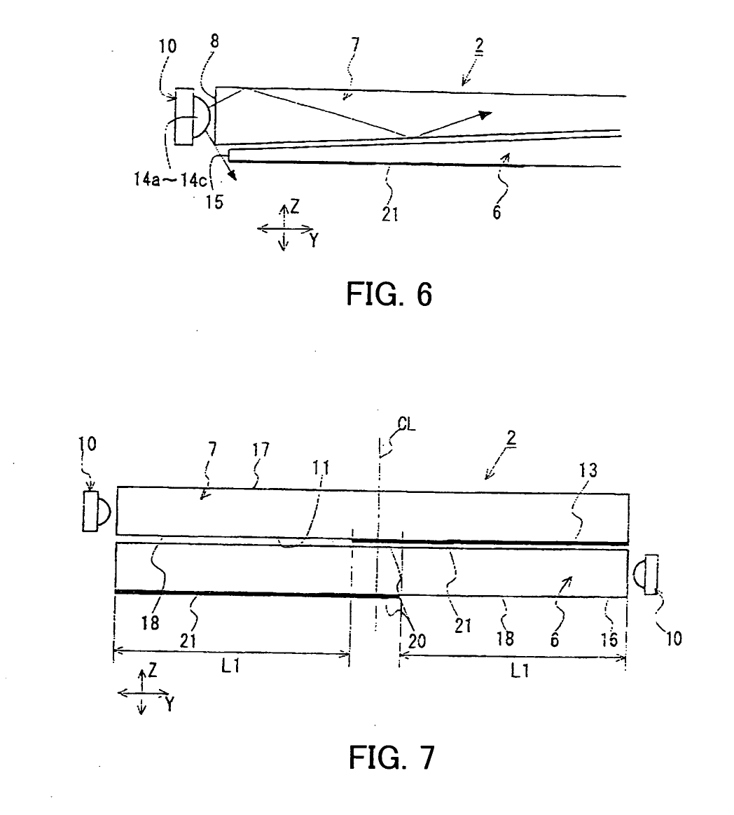

FIG. 6 is a partial cross section view of Modification 2 of surface light source device 2 shown in FIGS. 3a, 3b. Referring to FIG. 6, distal end face 15 of first light guide plate 6 is located somewhat far back from incidence face 8 of second light guide plate 7 along Y-direction. Second illumination light is prevented from entering directly into first light guide plate 6 through distal end face 15 of first light guide plate 6.

It is noted, although not illustrated], that distal end face 15 of second light guide plate 7 is located somewhat far back from incidence face 8 of first light guide plate 6 along Y-direction. This prevents first illumination light from entering directly into second light guide plate 7 through distal end face 15 of second light guide plate 7. Effects and advantages generally the same as those of Modification 1 can be expected in the case of Modification 2.

(Modification 3)

FIG. 7 is a diagram illustrating Modification 3 of surface light source device 2 shown in FIGS. 1 to 3a, 3b. Referring to FIG. 7, first light guide plate 6 and second light guide plate 7 of surface light source device 2 are shaped like rectangles and has wedge-like cross sections, and emission face 13 and back face 16 extend in parallel to each other, and emission face 17 and back face 11 extend in parallel to each other.

This renders thickness of surface light source device 2 increased. However, the vicinity of incidence face 8 of second light guide plate 7 is prevented from emitting light with short of color-mixing (short of whitening, in the embodiment), with the result that emission of still uniformly color-mixed (whitened, in the embodiment) light can be expected.

(Modification 4)

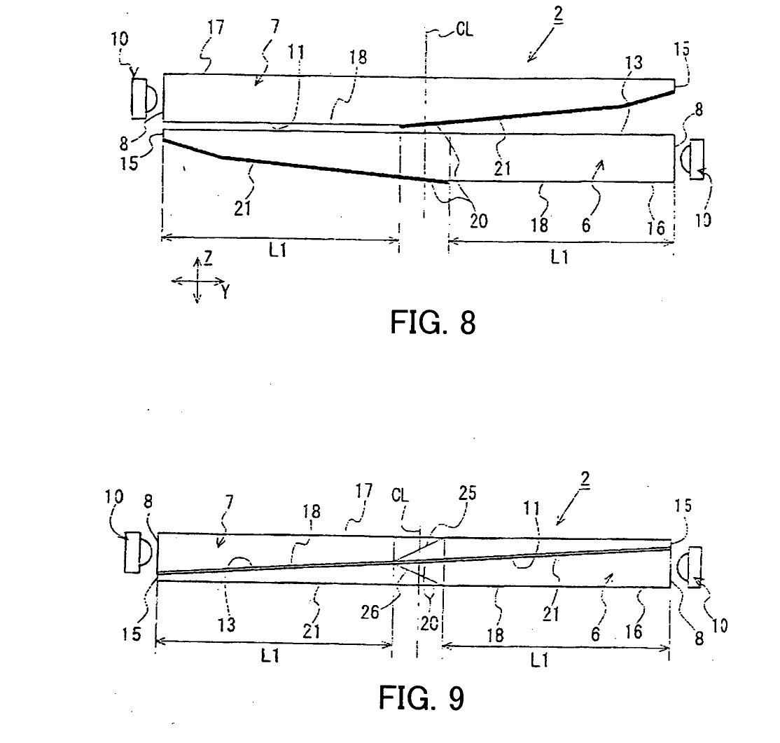

FIG. 8 is a diagram illustrating Modification 4 of surface light source device 2 shown in FIGS. 1 to 3a, 3b. Referring to FIG. 8, emission face 13, 17 and back faces 16, 11 extend in parallel to each other, respectively, in emission-restraint-regions 18 of first light guide plate 6 and second light guide plate 7. Thickness of first light guide plate 6 and light guide plate 7 decreases gradually away from respective incidence faces 8 in respective emission-gradual-increase-regions 20 and emission-promotion-regions 21. Inclination angles of back faces 16, 11 giving wedge-like shapes to first light guide plate 6 and second light guide plate 7 are great the vicinity of distal end faces 15.

Such partially wedge-like configuration causes emission in the vicinity of incidence face 8 and distal end face 15 of first light guide plate 6 to be increased somewhat. Effects and advantages generally the same as those of the above-described surface light source devices 2 can be expected in the case of Modification 4.

(Modification 5)

FIG. 9 is a diagram illustrating Modification 5 of surface light source device 2 shown in FIGS. 1 to 3a, 3b. Referring to FIG. 9, modification is applied to respective emission-gradual-increase-regions 20 of first light guide plate 6 and second light guide plate 7. Thickness of first light guide plate 6 and light guide plate 7.

In the first place, emission-gradual-increase-region (first emission-gradual-increase-region) 20 of first light guide plate 6 is divided into two wedge-like regions (having triangle-like cross sections) by division line 26 running obliquely from an end portion (on back face 16) near to incidence face 8 to another end portion (on emission face 13) near to distal end face 15. The lower wedge-like region of these two wedge-like regions in FIG. 9 contains numerous light scattering elements inside while the upper wedge-like region contains no light scattering element.

On the other hand, emission-gradual-increase-region (second emission-gradual-increase-region) 20 of second light guide plate 7 is divided into two wedge-like regions (having triangle-like cross sections) by division line 25 running obliquely from an end portion (on back face 11) near to incidence face 8 to another end portion (on emission face 17) near to distal end face 15.

The lower wedge-like region of these two wedge-like regions in FIG. 9 contains numerous light scattering elements inside while the upper wedge-like region contains no light scattering element. It is noted that matrix (base material) of first light guide plate 6 and second light guide plate 7 is a transparent resin. In addition, micro-particles made of material different from the transparent resin in refractive index.

According to Modification 5, light scattering ability in respective emission-gradual-increase-regions 20 of first light guide plate 6 and second light guide plate 7 increases gradually away from respective emission-restraint-regions 18 toward respective emission-promotion-regions 21, thereby providing gradually increasing emission brightness. It is noted that back faces 16, 11 may provide, in sections corresponding to emission-restraint-regions 18, flat and smooth surfaces generally the same as surfaces in emission-restraint-regions 18.

(Modification 6)

According to various examples, LEDs 14a, 14b and 14c emitting light of primary colors R, (red), G (green) and B (blue) are employed as point-like-light-sources of mutually different emission colors. However, this does not limit the scope of the present invention.

For example, a plurality of white point-like-light-sources (white LEDs) having a small tint unevenness of emission color may be employed instead of respective primary color LEDs 14a, 14b and 14c. It is noted that commercially available LEDs show tint unevenness of emission color to some degree in many cases. Example are somewhat reddish white light, bluish white light, greenish white light, yellowish white light etc.

In such cases, even if white LEDs picked up at random are employed, for example, instead of primary color LEDs 14a to 14c, the above-described color-mixing effect (emission after sufficient color-mixing) avoids tint from being conspicuous.

To the contrary, according to prior arts, tint unevenness is made inconspicuous by selecting only a particular tint (for example, only bluish white light LEDs). However, such selecting requires severely great working load. The present invention applied, even if a plurality of point-like-light-sources (such as white LEDs) having tint unevenness of emission color are employed without being selected as above, tint unevenness hardly appears.

(Modification 7)

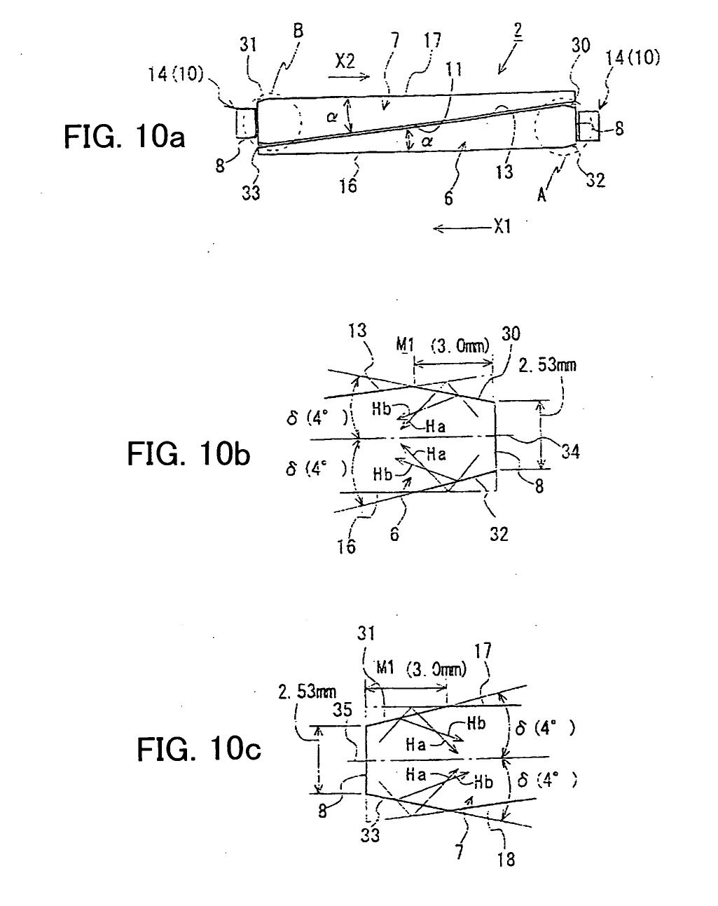

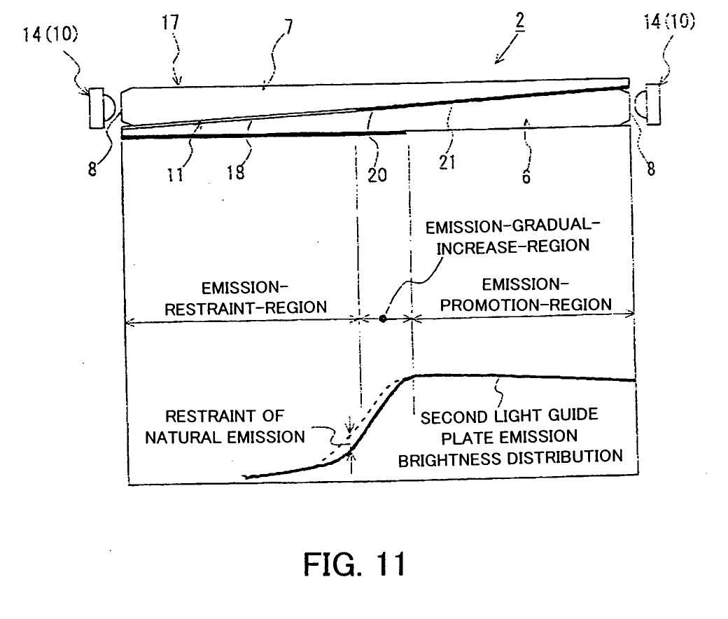

FIG. 10a is a cross section view of surface light source device 2 in accordance with Modification 7 and FIG. 10b is an enlarged view of part A in FIG. 10a. In addition, FIG. 10c is an enlarged view of part B in FIG. 10a. Further, FIG. 11 is a diagram showing a brightness distribution curve of emission from second light guide plate 7 together with a cross section shape diagram, illustrated correspondingly, of surface light source device in accordance 2 in accordance with Modification 7.

Referring to these figures, point-like-light-source units 10 consisting of a plurality of LEDs 14 of primary emission colors are disposed along incidence faces 8 of first light guide plate 6 and second light guide plate 7. According to a feature of Modification 7, first reflection surfaces 30, 31 are formed in the vicinity of upper ends of incidence faces 8 of light guide plates 6, 7, respectively, and second reflection surfaces 32, 33 are formed in the vicinity of lower ends of incidence faces 8 of light guide plates 6, 7, respectively.

Reflection surfaces 30 and 32 provide slopes each inclined by angle δ with respect to an imaginary plane 34 parallel to back face 16. It is noted, however, that reflection surfaces 30 and 32 are inclined inversely to each other so that thickness of first light guide plate 6 increases away from incidence face 8.

On the other hand, reflection surfaces 31 and 33 also provide slopes each inclined by angle δ with respect to an imaginary plane 35 parallel to emission face 17 as shown in FIG. 10c. Reflection surfaces 31 and 33 are inclined inversely to each other so that thickness of second light guide plate 7 increases away from incidence face 8.

In the illustrated example, as shown in FIGS. 10a and 10b, thickness of first light guide plate 6 in a covering range of first reflection surface 30 and second reflection surface 32 (from incidence face 8 to a location of predetermined distance M1) gives a gradual increase away from incidence face 8 along a direction of arrow X1 in FIG. 10a. In addition, thickness gives a gradual decrease starting at vanishing points of first reflection surface 30 and second reflection surface 32 away from there along the direction of arrow X1 in FIG. 10a.

On the other hand, as shown in FIGS. 10a and 10c, thickness of second light guide plate 7 in a covering range of first reflection surface 31 and second reflection surface 33 (from incidence face 8 to a location of predetermined distance M2) gives a gradual increase away from incidence face 8 along a direction of arrow X2 in FIG. 10a. In addition, thickness gives a gradual decrease starting at vanishing points of first reflection surface 31 and second reflection surface 33 away from there along the direction of arrow X2 in FIG. 10a.

According to this Modification 7, since first reflection surfaces 30, 31 and second reflection surfaces 32, 33 are formed, inner-propagation light propagating within respective light guide plates 6, 7 are redirected on being inner-reflected by these reflection surfaces so that propagation direction after being inner-reflected becomes closer to a direction parallel to back face 16 or emission face 17 as compared with cases where the reflection surfaces (inversely inclined slopes) are not formed (See FIG. 2a).

In FIG. 10b, Ha shows an example of direction inner-reflected light under absence of reflection surfaces 30, 32 and Hb shows an example of direction inner-reflected light under existence of reflection surfaces 30, 32 according to Modification 7. Further, in FIG. 10c, Ha shows an example of direction inner-reflected light under absence of reflection surfaces 31, 33 and Hb shows an example of direction inner-reflected light under existence of reflection surfaces 31, 33 according to Modification 7.

Needless to say, Hb is difficult to escape from light guide plate 6 or 7 as compared with Ha. Therefore emission from emission face 13 or 17 within each emission-restraint-region 18 (natural emission) can be reduced more effectively in Modification 7.

Modification 7 is suitable for cases where light guide plates 6 and 7 are shaped like wedges (See FIG. 2a).

Now provided that α gives inclination angle of both emission face 13 of first light guide plate 6 and back face 11 of second light guide plate 7, merits of Modification 7 are striking under great values of α (sharp inclination).

If inclination angle α is large, it is afraid that repeated inner-reflections at emission face 13 and back face 16 and at emission face 17 and back face 11 occur excessively in the vicinity of incidence faces 8. This is because inner-reflection angles to emission face 13 or emission face 17 are apt to be smaller than critical angle in the vicinity of incidence faces 8.

As described above, if Modification 7 is employed, inner-propagation light of light guide plates 6, 7 is restrained from being inner-incident to emission face 13 or emission face 17 at inner-incidence angles smaller than critical angle in the vicinity of incidence faces 8. As a result, respective emission-restraint-regions 18 function better and emission before sufficient color-mixing is restrained, leading to more inconspicuous color unevenness.

It is noted that numeral values are shown in FIGS. 10b and 10c. These numeral values are examples shown for the sake of easier understanding. As shown in FIGS. 10b and 10c, thickness of each of first light guide plate 6 and second light guide plate 7 is 2.53 mm at incidence face 8 and reflection surfaces are formed so that δ is 4° and M1 is equal to 3 mm.

These numerical values are merely give examples and optimum numerical values are preferably set depending on various conditions such as light emission are of light guide plates 6, 7.

(Modification 8)

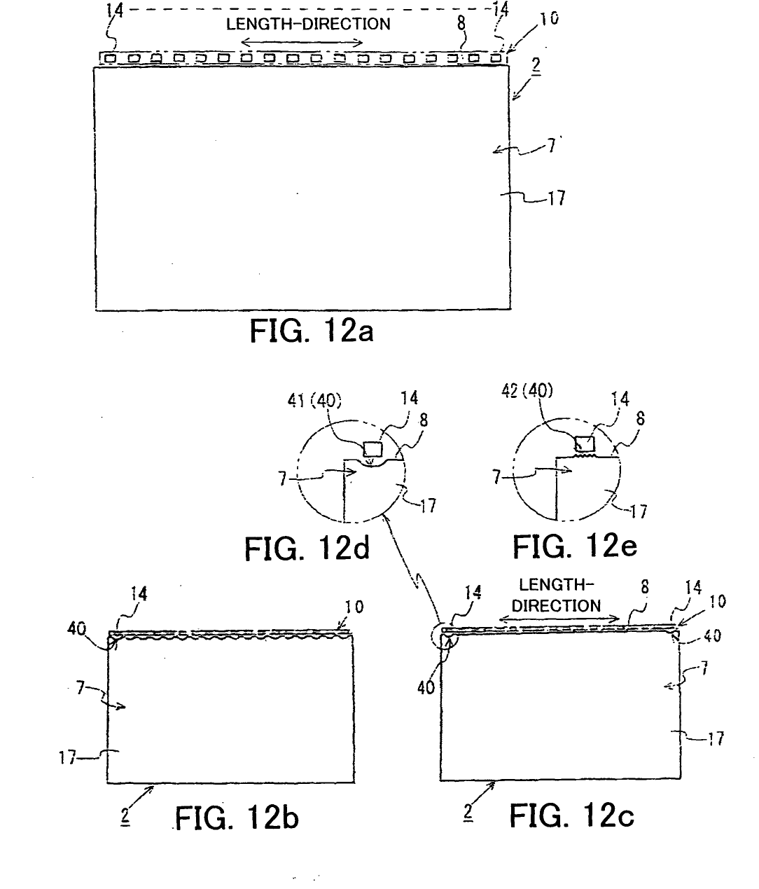

FIG. 12a is a plan view of surface light source device 2 in accordance with Modification 8 in a case where an incidence face is provided with no angle-expansion-means, with the side of first light guide plate 6 being not shown. Further, FIG. 12b is a plan view for illustrating a surface light source device of reference to be compared with Modification 8, with the side of first light guide plate 6 being not shown. In addition, FIG. 12c is a plan view of surface light source device 2 in accordance with Modification 8, with the side of first light guide plate 6 being not shown. Still further, FIG. 12d is a partially enlarge 4d view of FIG. 12c. Finally, FIG. 12e illustrates another mode of angle-expansion-means (illustrated correspondingly to FIG. 10d).

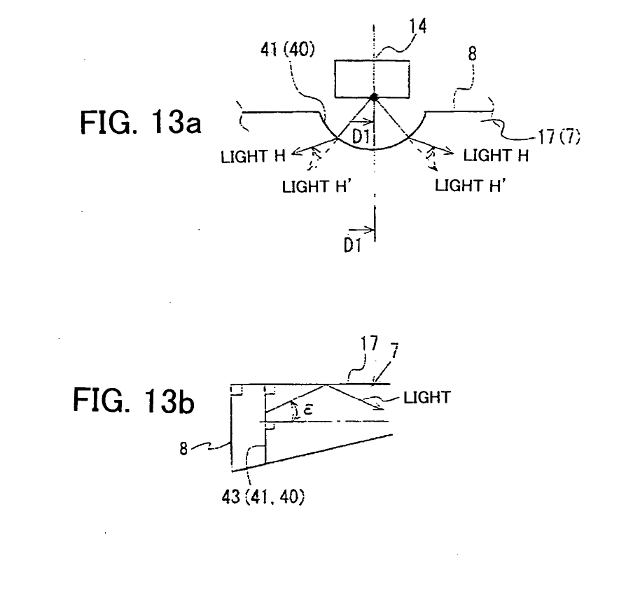

On the other hand, FIG. 13a is an enlarged view of a main part of FIG. 12d and FIG. 13b is a cross section view along line D1-D1 in FIG. 13a.

Surface light source device 2 shown in FIG. 12a has second light guide plate 7 at incidence face 8 of which no angle-expansion-means is formed, namely, to which modification according to Modification 8 has not been applied yet.

Referring to FIG. 12b, angle-expansion-means 60 are formed at incidence face 8 of second light guide plate 7 as to be opposite to LEDs 14 in one-to-one correspondence. Referring to FIG. 12c, angle-expansion-means 40 are disposed as to be opposite to both side LEDs 14 of a plurality of LEDs 14 consisting of point-like-light-source unit 10. FIG. 12d is an enlarged illustration of angle-expansion-means 40 shown in FIG. 12c.

In addition, FIG. 12d shows angle-expansion-means 40 structured differently as compared with angle-expansion-means 40 shown in FIG. 12d.

According to an example shown in FIG. 12c, incidence face 8 of second light guide plate 7 is provided with angle-expansion-means 40 which are disposed at locations corresponding to LEDs 14 located at both sides of incidence face 8.

Although such angle-expansion-means 40 cause light H′ from LEDs 40 to be expanded as to be come near to length-direction of incidence face 8 after entering into second light guide plate 7 (See light H in FIG. 13), light guiding is performed so that expansion regarding a direction of thickness of second light guide plate 7 is not caused (namely, so that c in FIG. 13b does not change).

Employable as angle-expansion-means 40 formed at incidence face 8 are, for example, recess 41 having an arc-like plan shape (See FIG. 12d) or rough surface 42 including continuously formed micro-projections each having a triangle-like plan shape (See FIG. 12e).

Side faces of recesses 41 or micro-projections providing rough surface 42 as angle-expansion-means 40 are formed as to be perpendicular to emission face 17 vertical to incidence face 8 (See FIG. 13b).

For comparison, now studied is surface light source device 2 having second light guide plate 7 at incidence face 8 of which no angle-expansion-means 40 is formed, by referring to FIG. 12a.

With surface light source device 2 shown in FIG. 12a, LEDs 14 located at both sides of incidence face 8 of second light guide plate 7 along length-direction of incidence face 8 emit light which is apt to be difficult to be mixed with light emitted from the other LEDs 14 within second light guide plate 7, depending on emission profiles of individual LEDs 14 constituting point-like-light-source unit 10.

As a result, color-mixing (, for example, whitening) of emission tends to be short in the vicinity of both side ends of incidence face 8 along length-direction thereof.

On the other hand, according to the instant Modification 8, LEDs 14 located at both sides of incidence face 8 of second light guide plate 7 along length-direction of incidence face 8 emit light which is guided as to be widely expanded by angle-expansion-means 40 as to be come near to length-direction of incidence face 8 (See FIG. 13a). Therefore color-mixing with light emitted from the other LEDs 14 can be realized broadly, being advantageous for reducing color unevenness.

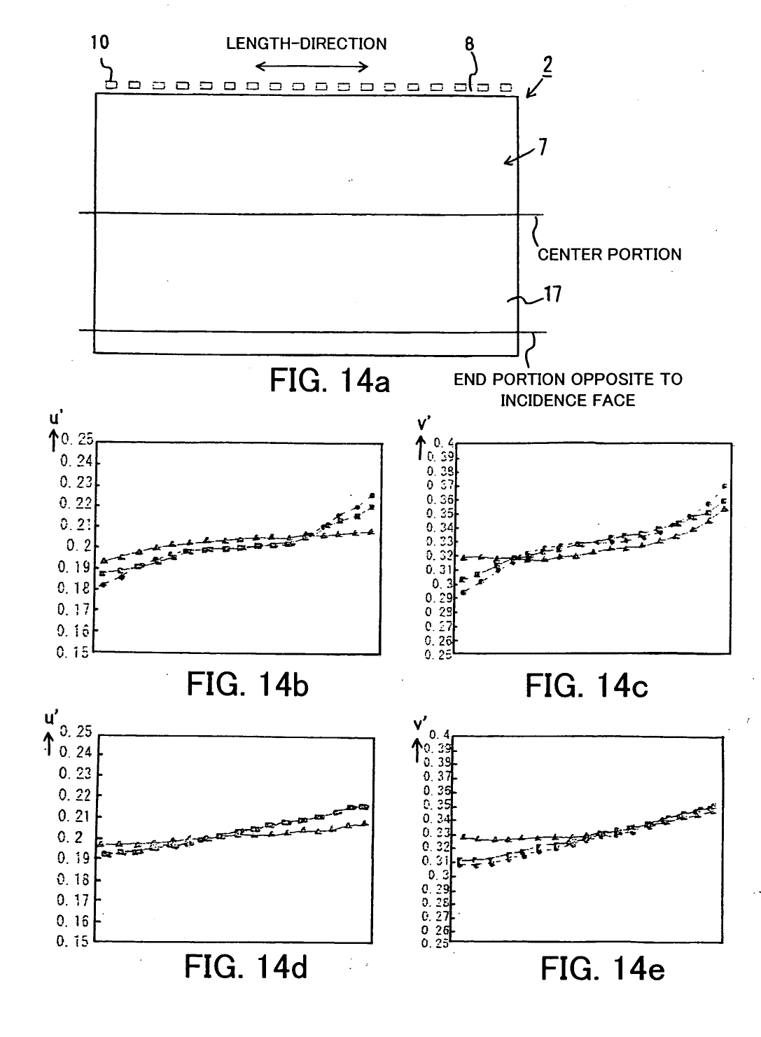

Next, FIG. 14a is a diagramic plan view of surface light source device 2 of Modification 8 as viewed from second light guide plate side for illustrating results of measurement performed for Modification 8. Results of measurement are shown in FIGS. 14b to 14e by using UCS chromaticity charts according to standard CIE 1976. Contents shown by the respective figures are as follows.
FIG. 14b; a chart showing u′ values (coordinate values for Red-Green axis in CIE 1976 UCS chromaticity chart) obtained through chromaticity measurement applied to a plurality of points in a center portion of second light guide plate 7 shown in FIG. 14a.
FIG. 14c; a chart showing v′ values (coordinate values for Yellow-Blue axis in CIE 1976 UCS chromaticity chart) obtained through chromaticity measurement applied to a plurality of points in the center portion of second light guide plate 7 shown in FIG. 14a.
FIG. 14d; a chart showing u′ values (coordinate values for Red-Green axis in CIE 1976 UCS chromaticity chart) obtained through chromaticity measurement applied to a plurality of points in an end portion opposite to incidence face 8 of second light guide plate 7 shown in FIG. 14a.
FIG. 14e; a chart showing v′ values (coordinate values for Yellow-Blue axis in CIE 1976 UCS chromaticity chart) obtained through chromaticity measurement applied to a plurality of points in the end portion opposite to incidence face 8 of second light guide plate 7 shown in FIG. 14a.

It is noted that axis of abscissas expresses, in each of FIGS. 14b to 14e, position along a width-direction of second light guide plate 7 parallel to incidence face 8. In addition, dotted lines and dots in FIGS. 14b to 14e give values of u′ and v′ of surface light source device 2 provided with no recess 41 at incidence face 8 (See FIG. 12a). Further, single-dotted-chain lines and dots ▪ give values of u′ and v′ of surface light source device 2 provided with recesses 41 are formed at incidence face 8 corresponding to respective LEDs 14 (See FIG. 12b). Still further, solid lines and dots ▴ give values of u′ and v′ of surface light source device 2 in accordance with the instant modification (See FIG. 12c).

According to surface light source device 2 (See FIG. 12c) in accordance with the instant modification, as illustrated in these FIGS. 14b to 14e, variation of chromaticity appearing on a cross sectional plane parallel to incidence face 8 can be reduced as compared with cases where incidence face 8 is a flat face (See FIG. 12a) or recesses 41 a respectively formed on incidence face 8 as to correspond to all LEDs 10 respectively (See FIG. 12b).

Although surface light source device 2 in accordance with the instant modification is described by seeing side of second light guide plate 7 exemplarily, the modification may be applied to side of first light guide plate 6 in a similar way. If so applied, angle-expansion-means 40 are formed on incidence face 8 of first light guide plate 6 at locations corresponding to both end LEDs 14 of the LEDs 14 disposed opposite to incidence face 8 of first light guide plate 6.

(Other Modifications)

Every mode above-described in the embodiment and modifications is an example in accordance with the present invention. Other modifications are employable as follows.

(A) Second light control member 5 may be a prism sheet directed downward instead of a prism sheet directed upward. The prism sheet directed downward is provided with a great number of prismatic projections on a face (inner face) opposite to first light control member 4.

(B) On the outside of the upward prism sheet employed in above (A), a third light control member (upward prism sheet) having prismatic projections running in a direction perpendicular to the running direction of the prismatic projections of the downward prism sheet may be disposed.

In general, numbers of prism sheets and running directions and shapes of prismatic projections may be changed depending on emission characteristics which surface light source device 2 is required. In some cases, no prism sheet may be disposed.

(C) A polarization separating sheet may be disposed on the side of emission face 13 of first light guide plate 6, as required. In this case, the polarization separating sheet renders only a required polarization component utilized as emission.

(D) According to the above-described the examples given by embodiment and modifications, emission-promotion-means is applied to the sides of back faces 16, 11 of first light guide plate 6 and second light guide plate 7, respectively. However, this does not limit the scope of the present invention.

For example, emission-promotion-means (such as rough surface) may be formed on emission face 13 instead of being formed on back face 16. In a similar way, emission-promotion-means (such as rough surface) may be formed on emission face 17 instead of being formed on back face 11.

(E) According to the above-described examples in embodiment and modifications, a plurality of sets of LEDs each consisting of LEDs 14a, 14b and 14c of R, G and B, As point-like-light-source unit 10. However, this does not limit the scope of the present invention.

For example, LEDs of emission colors other than R, G and B. In general, emission colors combined may be chosen depending on emission color which is desired as that of light emitted from emission face 17.

In many cases, desirable emission color of light emitted from emission face 17 is white, as described in the above embodiments and modifications.

In such cases, combination of point-like-light-sources are chosen for the first and second point-like-light-source units so that white light is generated by color-mixing. Employment of LEDs 14a, 14b and 14c of primary emission colors, R, G and B is a typical example for the case. As known well, white light is used for backlighting color-displaying LCD-panel.

(F) Reflection sheet 12 may be omitted. For example, if a housing accommodating surface light source device 2 has a light reflective inner surface, the inner face may be utilized instead of reflection sheet 12.

(G) Surface light source devices 2 and displays 1 in accordance with the present invention may used under postures other than the posture described in the above-described embodiment and modifications. In other words, the wording of up and down is used for the sake of easier explanation in the above-described embodiment and modifications. For example, surface light source device 2 may output illumination light downward for illuminating a LCD-panel disposed below surface light source device 2.

1. A surface light source device comprising:
a first light guide plate having a first side end face, a first emission face and a first back face opposite to said first emission face;
a first light source group for supplying first illumination light which is disposed along said first side end face and consists of at least two point-like-light-sources providing light of mutually different colors;
a second light guide plate having a second side end face, a second emission face and a second back face opposite to said second emission face;
a second light source group for supplying second illumination light which is disposed along said second side end face and consists of at least two point-like-light-sources providing light of mutually different colors; and
a layer refractive index of which is lower than that of first light guide plate, wherein
said first light guide plate and said second light guide plate are stack-disposed so that said layer is interposed between said first emission face of said first light guide plate and said second back face of said second light guide plate and said first side end face is located oppositely to said second side end face,
said first light guide plate having a first emission-restraint-region for restraining said first illumination light from being emitted from said first emission face, a first emission-promotion-region for promoting emission of said first illumination light from said first emission face and a first emission-gradual-increase-region bridging said first emission-restraint-region and said first emission-promotion-region;
said second light guide plate having a second emission-restraint-region for restraining said second illumination light from being emitted from said second emission face, a second emission-promotion-region for promoting emission of said second illumination light from said second emission face and a second emission-gradual-increase-region bridging said second emission-restraint-region and said second emission-promotion-region;
said first emission-restraint-region being located nearer to said first side end face than said first emission-gradual-increase-region and said first emission-promotion-region being located father from said first side end face than said first emission-gradual-increase-region; and
said second emission-restraint-region being located nearer to said second side end face than said second emission-gradual-increase-region and said second emission-promotion-region being located father from said second side end face than said second emission-gradual-increase-region.

2. A surface light source device in accordance with claim 1, wherein illumination output light outputted from said second emission face is white light.

3. A surface light source device in accordance with claim 2, wherein thickness of said first light guide plate decreases gradually away from said first side end face as to render said first light guide plate configured wedge-like and thickness of said second light guide plate decreases gradually away from said second side end face as to render said second light guide plate configured wedge-like.

4. A surface light source device in accordance with claim 2, wherein thickness of said first light guide plate decreases gradually in said first emission-promotion-region away from said first side end face and thickness of said second light guide plate decreases gradually in said second emission-promotion-region away from said second side end face.

5. A surface light source device in accordance with claim 2, wherein said first light guide plate is shaded at a distal end located opposite to said first side end face and said second light guide plate is shaded at a distal end located opposite to said second side end face.

6. A surface light source device in accordance with claim 3, wherein said first light guide plate is shaded at a distal end located opposite to said first side end face and said second light guide plate is shaded at a distal end located opposite to said second side end face.

7. A surface light source device in accordance with claim 4, wherein said first light guide plate is shaded at a distal end located opposite to said first side end face and said second light guide plate is shaded at a distal end located opposite to said second side end face.

8. A display comprising:
a surface light source device; and
a displaying member illuminated by output light outputted from said surface light source device, wherein said surface light source device is accordance with claim 2.

9. A display comprising:
a surface light source device; and a displaying member illuminated by output light outputted from said surface light source device, wherein said surface light source device is accordance with claim 3.

10. A display comprising:
a surface light source device; and a displaying member illuminated by output light outputted from said surface light source device, wherein said surface light source device is accordance with claim 4.

11. A display comprising:
a surface light source device; and a displaying member illuminated by output light outputted from said surface light source device, wherein said surface light source device is accordance with claim 5.

12. A display comprising:
a surface light source device; and a displaying member illuminated by output light outputted from said surface light source device, wherein said surface light source device is accordance with claim 6.

13. A surface light source device in accordance with claim 1, wherein thickness of said first light guide plate decreases gradually away from said first side end face as to render said first light guide plate configured wedge-like and thickness of said second light guide plate decreases gradually away from said second side end face as to render said second light guide plate configured wedge-like.

14. A surface light source device in accordance with claim 1, wherein thickness of said first light guide plate decreases gradually in said first emission-promotion-region away from said first side end face and thickness of said second light guide plate decreases gradually in said second emission-promotion-region away from said second side end face.

15. A surface light source device in accordance with claim 1, wherein said first light guide plate is shaded at a distal end located opposite to said first side end face and said second light guide plate is shaded at a distal end located opposite to said second side end face.

16. A display comprising:
a surface light source device; and
a displaying member illuminated by output light outputted from said surface light source device, wherein said surface light source device is accordance with claim 1.
